(19) United States
(12) Patent Application Publication
(10) Pub. No.: US 2026/0244946 A1
(43) Pub. Date: Aug. 20, 2026

(54) INTENT RECOGNITION METHODS AND APPARATUSES, DEVICES, AND READABLE STORAGE MEDIA

(71) Applicant: ALIPAY (HANGZHOU) INFORMATION TECHNOLOGY CO., LTD., Hangzhou (CN)

(72) Inventors: Haotian WANG, Hangzhou (CN); Xiaofeng WU, Hangzhou (CN); Weiqiang WANG, Hangzhou (CN)

(21) Appl. No.: 18/872,230

(22) PCT Filed: Aug. 1, 2023
(86) PCT No.: PCT/CN2023/110632

§ 371 Date: Dec. 5, 2024

(30) Foreign Application Priority Data
Nov. 3, 2022 (CN) 202211370268.5

(51) Int. Cl. G06N 5/022

(52) U.S. Cl. CPC G06N 5/022

(57) ABSTRACT

This specification discloses an intent recognition method and apparatus, a device, and a readable storage medium. To-be-recognized information is matched with each preset keyword, to obtain a target keyword that matches the to-be-recognized information; a historical dialogue record of a target user is searched, based on the target keyword, for reference output information corresponding to the target keyword and reference reply information input by the target user for the reference output information; and then the to-be-recognized information and the reference reply information are input to a pre-trained intent recognition model, to obtain an intent output by the model as a target intent of the to-be-recognized information.

### TECHNICAL FIELD

This specification relates to the field of computer technologies, and in particular, to intent recognition methods and apparatuses, devices, and readable storage media.

### BACKGROUND

With increasing attention to privacy data, the man-machine interaction field has also received widespread attention. Currently, an intelligent dialogue system can recognize intents of users by using dialogue data input by the users, and output intelligent dialogue data that matches the intents of the users, to smoothly communicate with the users. Therefore, improving accuracy of recognizing intents of users becomes an urgent problem to be resolved.

Based on this, this specification provides an intent recognition method.

### SUMMARY

This specification provides intent recognition methods and apparatuses, devices, and readable storage media, to partially resolve the above problems existing in a related technology.

This specification uses the following technical solution. This specification provides an intent recognition method, including: receiving an intent recognition request, and determining reply information input by a target user for output information of an intelligent dialogue system as to-be-recognized information; matching the to-be-recognized information with each preset keyword, to obtain a target keyword that matches the to-be-recognized information; searching, based on the target keyword and a preset correspondence between historical output information and a keyword, a historical dialogue record of the target user for reference output information corresponding to the target keyword and reference reply information input by the target user for the reference output information; and inputting the to-be-recognized information and the reference reply information to a pre-trained intent recognition model as inputs, to obtain an intent output by the intent recognition model as a target intent of the to-be-recognized information, where the intent recognition model is trained by using the following method: determining a first training sample based on historical output information output by the intelligent dialogue system and historical reply information input by a reference user for the historical output information in a specified round of historical dialogue between the intelligent dialogue system and the reference user, determining a label of the first training sample based on an intent of the reference user corresponding to the specified round of historical dialogue, and training the intent recognition model based on the first training sample and the label of the first training sample.

This specification provides an intent recognition apparatus, including: a receiving module, configured to: receive an intent recognition request, and determine reply information input by a target user for output information of an intelligent dialogue system as to-be-recognized information; a matching module, configured to match the to-be-recognized information with each preset keyword, to obtain a target keyword that matches the to-be-recognized information; a searching module, configured to search, based on the target keyword and a preset correspondence between historical output information and a keyword, a historical dialogue record of the target user for reference output information corresponding to the target keyword and reference reply information input by the target user for the reference output information; and a recognition module, configured to input the to-be-recognized information and the reference reply information to a pre-trained intent recognition model as inputs, to obtain an intent output by the intent recognition model as a target intent of the to-be-recognized information.

This specification provides a non-transitory computer-readable storage medium. The storage medium stores a computer program, and when the computer program is executed by a processor, the above intent recognition method is implemented.

This specification provides an electronic device, including a storage, a processor, and a computer program that is stored in the storage and that is capable of running on the processor. When the processor executes the program, the above intent recognition method is implemented.

The above at least one technical solution used in this specification can achieve the following beneficial effects: In the intent recognition method provided in this specification, to-be-recognized information is matched with each preset keyword, to obtain a target keyword that matches the to-be-recognized information; a historical dialogue record of a target user is searched, based on the target keyword, for reference output information corresponding to the target keyword and reference reply information input by the target user for the reference output information; and then the to-be-recognized information and the reference reply information are input to a pre-trained intent recognition model, to obtain an intent output by the model as a target intent of the to-be-recognized information. It can be learned that in the manner of searching for the reference output information and the reference reply information based on the target keyword that matches the to-be-recognized information, an existing training manner and model structure of the intent recognition model do not need to be adjusted, and intent recognition can be performed with reference to a plurality of rounds of dialogues, to improve accuracy of intent recognition.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification. In the accompanying drawings:

FIG. 1 is a schematic flowchart of an intent recognition method according to this specification;

FIG. 2 is a schematic flowchart of an intent recognition method according to this specification;

FIG. 3 is a schematic diagram of an intent recognition apparatus according to this specification; and

FIG. 4 is a schematic diagram of an electronic device corresponding to FIG. 1 according to this specification.

### DESCRIPTION OF EMBODIMENTS

To make the objectives, technical solutions, and advantages of this specification clearer, the following clearly and comprehensively describes the technical solutions of this specification with reference to specific embodiments and corresponding accompanying drawings of this specification. Clearly, the described embodiments are merely some but not all of embodiments of this specification. All other embodiments obtained by a person of ordinary skill in the art based on the embodiment of this specification without creative efforts shall fall within the protection scope of this specification.

In addition, it should be noted that all actions of obtaining a signal, information, or data in this specification are performed in compliance with corresponding data protection laws and policies of local countries and with authorization from corresponding apparatus owners.

In a man-machine dialogue, a certain dialogue language is used between a user and an intelligent dialogue system to exchange information between the person and the intelligent dialogue system in a specific interaction manner. In a man-machine dialogue process, the intelligent dialogue system usually performs intent recognition on voice or text information input by the user, to obtain an intent of the user, and then obtains an output result based on the intent, to complete the dialogue with the user.

However, in actual applications, the user may deny a previous answer in a certain round of dialogue in a plurality of rounds of dialogues. In this case, if an intent recognition model is obtained through training by using dialogue data of a single round of dialogue as a training sample and a user intent in the single round of dialogue as a label of the training sample, an intent of the user in the plurality of rounds of dialogues cannot be output for the above case. However, if the intent recognition model is trained by using dialogue data of a plurality of rounds of dialogues as a training sample and a user intent in the plurality of rounds of dialogues as a label, in a training process, there are problems that it is difficult to implement manual labeling, a large quantity of computing resources are occupied for model training, and prediction efficiency is low.

Based on this, this specification provides an intent recognition method. An intent jointly predicted based on to-be-recognized information and reference reply information is used as a target intent corresponding to the to-be-recognized information, an existing training manner and model structure of an intent recognition model do not need to be adjusted, and intent recognition can be performed with reference to a plurality of rounds of dialogues, to improve accuracy of intent recognition.

The technical solutions provided in the embodiments of this specification are described in detail below with reference to the accompanying drawings.

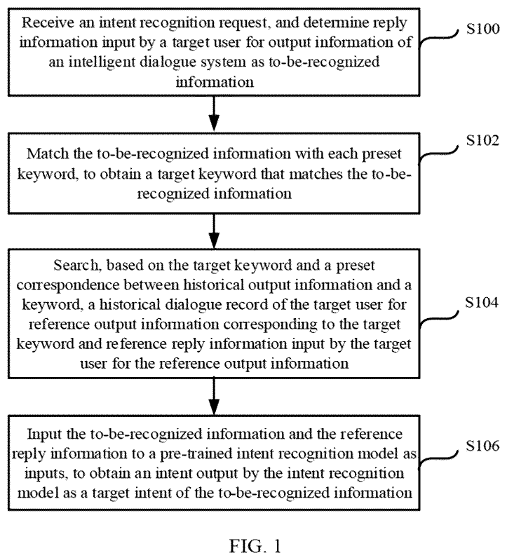

FIG. 1 is a schematic flowchart of an intent recognition method according to this specification.

S100: Receive an intent recognition request, and determine reply information input by a target user for output information of an intelligent dialogue system as to-be-recognized information.

With rapid development of Internet technologies, increasingly more users execute online transaction services by using a service platform. In addition, there may be cases in which users suffer online fraud and execute online transactions with a transaction risk. In the above cases, the service platform can exchange information with the user through a plurality of rounds of dialogues in a manner such as making an outbound call or actively initiating a dialogue, to recognize whether there is a risk in the transaction service executed by the user, so as to discover a risk in a timely manner, alert the user, and avoid an infringement of user interests.

In this embodiment of this specification, each round of dialogue between the intelligent dialogue system and the target user can include historical output information output by the intelligent dialogue system and historical reply information input by the user. Optionally, in a scenario in which it is determined, in a man-machine dialogue manner, whether the target user has an abnormal behavior, the intelligent dialogue system usually raises a question, and the user inputs an answer to the question. Therefore, the historical output information output by the intelligent dialogue system can be a historical question, and the historical reply information input by the target user can be a historical answer to the historical question.

Specifically, the intent recognition request is received. The intent recognition request can carry the reply information input by the target user for the output information of the intelligent dialogue system, and the reply information can be used as the to-be-recognized information. A specific man-machine dialogue manner between the target user and the intelligent dialogue system can be any existing man-machine dialogue manner such as a voice, a text, or a picture. This is not limited in this specification.

S102: Match the to-be-recognized information with each preset keyword, to obtain a target keyword that matches the to-be-recognized information.

In a man-machine dialogue process between the intelligent dialogue system and the target user, the intelligent dialogue system may repeatedly ask the user questions of the same type. However, in actual applications, the target user may provide completely different replies for questions of the same type. For example, the two questions “Is the transaction you have just executed for a brushing task?” and “Are you engaged in brushing on the shopping platform?” are not completely consistent, but are of the same type, and are both used to ask whether the target user has an abnormal behavior of brushing. Based on the above actual situation, it is difficult for an intent recognition model trained only by using dialogue data of a single round as a training sample to accurately recognize a real intent of the target user from the completely different replies provided by the target user for the questions of the same type.

Therefore, historical output information in a historical dialogue record can be classified in advance, to obtain a keyword corresponding to the historical output information, so as to determine a type of the output information to which the to-be-recognized information responds, and find a plurality of pieces of reply information input by the target user for output information of the same type, so that when a target intent corresponding to the to-be-recognized information is determined, the to-be-recognized information is comprehensively obtained with reference to the plurality of pieces of reply information provided by the target user for the output information of the same type in the plurality of rounds of dialogues.

S104: Search, based on the target keyword and a preset correspondence between historical output information and a keyword, a historical dialogue record of the target user for reference output information corresponding to the target keyword and reference reply information input by the target user for the reference output information.

Specifically, the keyword of the historical output information can be obtained through manual labeling, and the historical output information can be classified. Certainly, the manual labeling manner requires a relatively high service level of a labeling person. Based on this, the correspondence between the historical output information and the keyword can be further established by using a pre-trained classification model based on a plurality of rounds of historical dialogue records, to classify the historical output information. One piece of historical output information can correspond to a plurality of keywords, and one keyword can correspond to a plurality of pieces of historical output information.

Further, the historical dialogue record between the target user and the intelligent dialogue system is searched for the reference output information corresponding to the target keyword. The historical dialogue record can be a historical dialogue record generated by the target user and the intelligent dialogue system by making a man-machine dialogue within a specified time period. Specific duration of the specified time period can be determined based on a specific application scenario. This is not limited in this specification.

Therefore, reference output information of the same type as the output information to which the to-be-recognized information responds can be obtained by searching for the keyword that matches the to-be-recognized information, and reference reply information input for a plurality of pieces of reference output information of the same type in the man-machine dialogue between the target user and the intelligent dialogue system within the specified time period can be further found. In this embodiment of this specification, in the method for recognizing the intent of the target user with reference to a plurality of pieces of reference reply information in the historical dialogue record, an objective of recognizing the intent of the target user with reference to a plurality of rounds of dialogues can be achieved without changing an existing model structure and training method of the intent recognition model. This achieves advantages of convenient labeling in intent prediction based on a single round of dialogue, low graphics memory occupation, and a high prediction speed, and further achieves an effect of jointly predicting an intent based on a plurality of rounds of dialogues.

S106: Input the to-be-recognized information and the reference reply information to a pre-trained intent recognition model as inputs, to obtain an intent output by the intent recognition model as a target intent of the to-be-recognized information.

In actual applications, in a man-machine dialogue process between the target user and the intelligent dialogue system, there may be a case in which the target user inputs different reply information for same output information. To improve accuracy of intent recognition in the above case, the reference output information is searched for by using the target keyword of the to-be-recognized information, and then the reference reply information input by the user for reference output information of the same type is determined.

Specifically, in this embodiment of this specification, the to-be-recognized information is concatenated with the reference reply information, and concatenated information is input to the pre-trained intent recognition model. If an intent of the reference reply information is consistent with the intent of the to-be-recognized information, the reference reply information and the to-be-recognized information are input to the intent recognition model, and the intent output by the model can be the same as or similar to the intent represented by the reference reply information. If the intent represented by the reference reply information is inconsistent with the intent represented by the to-be-recognized information, the reference reply information and the to-be-recognized information are input to the intent recognition model, and the intent output by the model may be opposite to the intent represented by the reference reply information.

In this embodiment of this specification, the intent recognition model can be trained in an existing training manner. Specifically, the intent recognition model is trained by using the following method:

A first training sample is determined based on historical output information output by the intelligent dialogue system and historical reply information input by a reference user for the historical output information in a specified round of historical dialogue between the intelligent dialogue system and the reference user, a label of the first training sample is determined based on an intent of the reference user corresponding to the specified round of historical dialogue, and the intent recognition model is trained based on the first training sample and the label of the first training sample.

Optionally, in this embodiment of this specification, a plurality of rounds of historical dialogue records of a plurality of rounds of historical dialogues between the intelligent dialogue system and the reference user are first obtained, and then at least one round of historical dialogue is selected from the plurality of rounds of historical dialogue records as the specified round of historical dialogue. A quantity and a dialogue time of specified rounds of historical dialogues are not limited in this specification. That is, in this embodiment of this specification, the intent recognition model can be trained by using historical output information and historical reply information in a single round of historical dialogue as the first training sample, and certainly, can also be trained by using a plurality of pieces of historical output information and a plurality of pieces of historical reply information in a plurality of rounds of historical dialogues as the first training sample.

Therefore, the training sample for the intent recognition model can be historical output information and historical reply information in a single round of historical dialogue record, and the label of the training sample can be a user intent represented by the single round of historical dialogue record. The label of the training sample can be obtained in any existing manner, for example, manual labeling. That is, in one or more embodiments of this specification, the used intent recognition model can also retain advantages of convenient labeling in intent prediction based on a single round of dialogue, low graphics memory occupation, and a high prediction speed.

In this embodiment of this specification, the training sample for the intent recognition model, the label of the training sample, a model structure, a training manner, etc. are not changed. Instead, a manner of obtaining the target keyword corresponding to the to-be-recognized information and searching for the reference output information corresponding to the to-be-recognized information is used to determine a plurality of pieces of reference reply information input by the target user for output information corresponding to the same keyword in the plurality of rounds of dialogues, and the intent of the target user is comprehensively recognized based on the to-be-recognized information and the plurality of pieces of reference reply information, so that when the target user provides different reply information, the intent of the target user can be obtained with reference to the plurality of rounds of dialogues.

In the intent recognition method provided in this specification, to-be-recognized information is matched with each preset keyword, to obtain a target keyword that matches the to-be-recognized information; a historical dialogue record of a target user is searched, based on the target keyword, for reference output information corresponding to the target keyword and reference reply information input by the target user for the reference output information; and then the to-be-recognized information and the reference reply information are input to a pre-trained intent recognition model, to obtain an intent output by the model as a target intent of the to-be-recognized information. It can be learned that in the manner of searching for the reference output information and the reference reply information based on the target keyword that matches the to-be-recognized information, an existing training manner and model structure of the intent recognition model do not need to be adjusted, and intent recognition can be performed with reference to a plurality of rounds of dialogues, to improve accuracy of intent recognition.

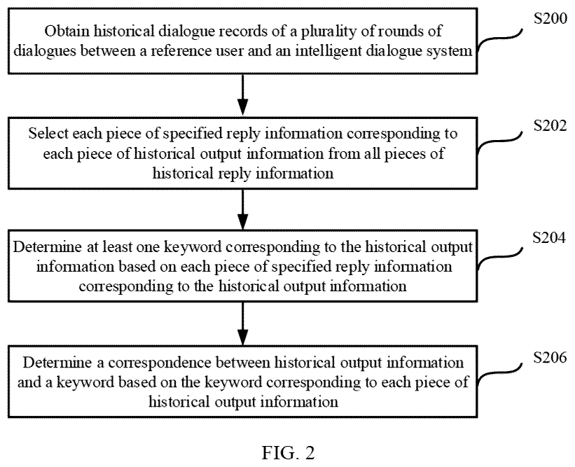

In one or more embodiments of this specification, before step S102 of matching the to-be-recognized information with each preset keyword, to obtain the target keyword that matches the to-be-recognized information in FIG. 1 is performed, the correspondence between each keyword and the historical output information can be determined based on historical dialogue records of a plurality of rounds of dialogues between the reference user and the intelligent dialogue system. This is specifically implemented by using the following steps S200 to S206, as shown in FIG. 2.

S200: Obtain historical dialogue records of a plurality of rounds of dialogues between the reference user and the intelligent dialogue system, where each round of historical dialogue record includes historical output information output by the intelligent dialogue system and historical reply information input by the reference user for the historical output information.

In actual applications, the preset correspondence between the historical output information and the keyword can be established through manually labeling, and at least one keyword of each piece of historical output information is manually extracted from a text of the historical output information based on semantics of the historical output information. However, this method requires an excessively high service capability of a labeling person, and a problem of incomplete labeling or incorrect labeling may occur. Therefore, in this embodiment of this specification, a correspondence between each piece of historical output information and each keyword is automatically established in a manner of extracting a keyword from dedicated reply information of the historical output information.

The historical dialogue records of the plurality of rounds of dialogues between the reference user and the intelligent dialogue system can be historical dialogue records of a plurality of rounds of dialogues respectively between the intelligent dialogue system and a plurality of different reference users within a preset time period. The reference users can include the target user. This is not limited in this specification.

The intent recognition method provided in one or more embodiments of this specification can be applied to a scenario in which an abnormal behavior of a user is recognized in an intelligent anti-fraud system. Therefore, historical output information output by the intelligent dialogue system and historical reply information input by the reference user for the historical output information can be recorded in each round of historical dialogue record.

S202: Select each piece of specified reply information corresponding to each piece of historical output information from all pieces of historical reply information.

Specifically, each piece of historical reply information is input to a pre-trained classification model, to obtain probabilities, output by the classification model, that the historical reply information corresponds to all pieces of historical output information.

In the man-machine dialogue process, the historical reply information input by the reference user for the historical output information can be in two forms. A first form is general reply information, indicating that the reply information can be used to respond to various types of output information, for example, “h'm”, “yes”, and “no”. A second form is dedicated reply information, indicating that the reply information can only be used to respond to output information corresponding to the reply information, for example, “I am not engaged in brushing” or “I have went shopping”. Usually, the dedicated reply information can include a type or a subject of the output information to which the dedicated reply information responds. Therefore, a keyword of the historical output information corresponding to the dedicated reply information can be determined by removing the general reply information, retaining the dedicated reply information, and extracting a keyword based on the dedicated reply information.

The classification model is obtained through training by using the following method:
Step 1: Use historical reply information in each round of historical dialogue record as a second training sample in advance, and use historical output information in the round of historical dialogue record as a label of the second training sample in advance.
Step 2: Input the second training sample to the to-be-trained classification model, to obtain prediction information that is of the second training sample and that is output by the classification model.
Step 3: Train the classification model by using a training objective of minimizing a difference between the prediction information of the second training sample and the label of the second training sample.

Therefore, the classification model can predict, based on the historical reply information, the probabilities that the historical reply information corresponds to all the pieces of historical output information. Usually, historical output information with a highest probability is historical output information to which the historical reply information responds. However, in actual applications, there is a specific quantity of pieces of general reply information in the historical dialogue record, and the general reply information is not removed from the training sample for the classification model. Therefore, the general reply information is input to the classification model, and probabilities, output by the model, that the general reply information corresponds to all the pieces of historical output information are usually similar. Therefore, further, a difference between the probabilities that the historical reply information corresponds to all the pieces of historical output information is determined, and each piece of historical reply information whose difference is greater than a preset difference threshold is used as each piece of candidate information.

Therefore, each piece of specified reply information corresponding to each piece of historical output information is selected from all the pieces of historical reply information based on a probability that each piece of candidate reply information separately corresponds to the historical output information.

S204: Determine at least one keyword corresponding to the historical output information based on each piece of specified reply information corresponding to the historical output information.

Specifically, each piece of specified reply information corresponding to the historical output information is separately segmented, to obtain candidate words; and each of the candidate words is input to the pre-trained intent recognition model, and the at least one keyword corresponding to the historical output information is selected from the candidate words based on an output of the intent recognition model.

For example, the historical output information is “Is the transaction you have just executed for a brushing task?”, and the specified reply information of the historical output information is “I am not engaged in brushing.” In this case, “I am not engaged in brushing” is segmented, to obtain single candidate words “I”, “am not engaged in”, and “brushing”, and further, each of the three candidate words is input to the pre-trained intent recognition model. Because the two keywords “I” and “am not engaged in” cannot represent any user intent, probabilities that the model outputs intents for the two keywords are relatively low. The keyword “brushing” can hit an abnormal behavior of “brushing”. Therefore, the specified reply information is segmented, to obtain candidate words, and then the keyword corresponding to the historical output information is selected from the candidate words.

One piece of historical output information can correspond to at least one keyword, and one keyword can correspond to at least one piece of historical output information.

S206: Determine the correspondence between the historical output information and the keyword based on the keyword corresponding to each piece of historical output information.

Based on the above solution, the general historical reply information is removed from each piece of historical reply information input by the reference user for each piece of historical output information, to obtain specified reply information separately corresponding to each piece of historical output information, and then at least one keyword corresponding to the historical output information is determined from the specified reply information, to establish the correspondence between each piece of historical output information and each keyword. It can be learned that in the manner of not manually establishing the correspondence between the historical output information and the keyword, a problem of incomplete labeling or incorrect labeling that may occur during manual labeling is avoided.

In one or more embodiments of this specification, a question to which the to-be-recognized information responds is a question used to ask whether the target user has an abnormal behavior.

Before searching for the reference output information corresponding to the target keyword and the reference reply information input by the target user for the reference output information is performed, it can be further determined that the to-be-recognized information includes a negative word.

In a scenario in which the intelligent dialogue system makes an outbound call to make a man-machine dialogue with the target user to determine whether the target user has an abnormal behavior, the intelligent dialogue system usually can output a question for asking whether the target user has an abnormal behavior. If the target user provides a positive reply to a question of the above type in first several rounds of dialogues in a plurality of rounds of dialogues, but provides a negative reply in a current round of dialogue, it indicates that a dialogue intent of the target user changes. In this case, the intent of the target user needs to be re-recognized, and then an intent of the target user in the first several rounds of dialogues needs to be corrected.

In one or more embodiments of this specification, after the target intent of the to-be-recognized information is obtained, as shown in step S106 in FIG. 1, an intent of the target user corresponding to the reference reply information can be further obtained, and the intent of the target user corresponding to the reference reply information can be adjusted based on the target intent, to determine, based on an adjusted intent, whether the target user has an abnormal behavior. Specifically, correction such as overwriting or adjustment can be performed on the intent of the target user corresponding to the reference reply information based on the target intent output by the intent recognition model based on the concatenated reply information.

For example, the output information of the intelligent dialogue system is “Is the transaction you have just executed for a brushing task?”, and the reply information input by the target user is “h'm”. In this case, the intent of the target user can be recognized as “brushing”. The intelligent dialogue system outputs “Are you engaged in brushing on the shopping platform?”, and the to-be-recognized information input by the target user is “I am not engaged in brushing”. In this case, “I am not engaged in brushing” and “h'm” can be concatenated and input to the pre-trained intent recognition model, to obtain information indicating that the intent that is of the target user and that is output by the intent recognition model is “not engaged in brushing”. Further, a case in which the intent is “brushing” in the historical dialogue record can be corrected based on the intent of “not engaged in brushing”, and a behavior of the user corresponding to a corrected historical dialogue is redefined, to improve accuracy of determining whether the target user has an abnormal behavior.

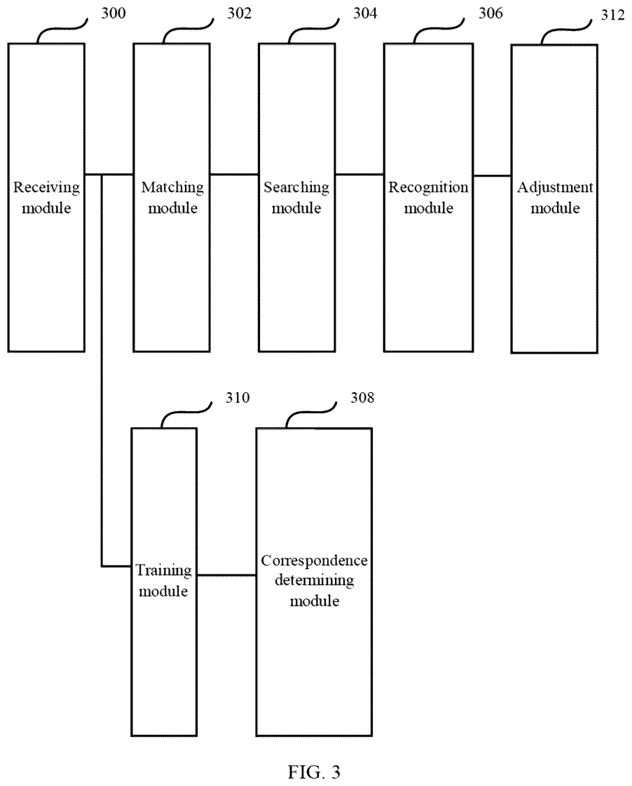

FIG. 3 is a schematic diagram of an intent recognition apparatus according to this specification. The apparatus specifically includes: a receiving module 300, configured to: receive an intent recognition request, and determine reply information input by a target user for output information of an intelligent dialogue system as to-be-recognized information; a matching module 302, configured to match the to-be-recognized information with each preset keyword, to obtain a target keyword that matches the to-be-recognized information; a searching module 304, configured to search, based on the target keyword and a preset correspondence between historical output information and a keyword, a historical dialogue record of the target user for reference output information corresponding to the target keyword and reference reply information input by the target user for the reference output information; and a recognition module 306, configured to input the to-be-recognized information and the reference reply information to a pre-trained intent recognition model as inputs, to obtain an intent output by the intent recognition model as a target intent of the to-be-recognized information.

Optionally, the apparatus further includes a correspondence determining module 308, specifically configured to: obtain historical dialogue records of a plurality of rounds of dialogues between a reference user and the intelligent dialogue system, where each round of historical dialogue record includes historical output information output by the intelligent dialogue system and historical reply information input by the reference user for the historical output information; select each piece of specified reply information corresponding to each piece of historical output information from all pieces of historical reply information; determine at least one keyword corresponding to the historical output information based on each piece of specified reply information corresponding to the historical output information; and determine the correspondence between the historical output information and the keyword based on the keyword corresponding to each piece of historical output information.

Optionally, the correspondence determining module 308 is specifically configured to: input each piece of historical reply information to a pre-trained classification model, to obtain probabilities, output by the classification model, that the historical reply information corresponds to all pieces of historical output information; determine a difference between the probabilities that the historical reply information corresponds to all the pieces of historical output information, and use each piece of historical reply information whose difference is greater than a preset difference threshold as each piece of candidate reply information; and select each piece of specified reply information corresponding to each piece of historical output information from all the pieces of historical reply information based on a probability that each piece of candidate reply information separately corresponds to the historical output information.

Optionally, the apparatus further includes a training module 310, specifically configured to: use historical reply information input by the reference user in each round of historical dialogue record as a second training sample in advance, and use historical output information to which the historical reply information responds in the round of historical dialogue record as a label of the second training sample in advance; input the second training sample to the to-be-trained classification model, to obtain prediction information that is of the second training sample and that is output by the classification model; and train the classification model by using a training objective of minimizing a difference between the prediction information of the second training sample and the label of the second training sample.

Optionally, the correspondence determining module 308 is specifically configured to: separately segment each piece of specified reply information corresponding to the historical output information, to obtain candidate words; and input each of the candidate words to the pre-trained intent recognition model, and select the at least one keyword corresponding to the historical output information from the candidate words based on an output of the intent recognition model.

Optionally, the output information that is of the intelligent dialogue system and to which the to-be-recognized information responds is a question used to ask whether the target user has an abnormal behavior; and optionally, before the searching module 304 searches for the reference output information corresponding to the target keyword and the reference reply information input by the target user for the reference output information, the searching module 304 is further configured to determine that the to-be-recognized information includes a negative word.

Optionally, the apparatus further includes an adjustment module 312, specifically configured to: obtain an intent of the target user corresponding to the reference reply information; and adjust the intent of the target user corresponding to the reference reply information based on the target intent, to determine, based on an adjusted intent, whether the target user has an abnormal behavior.

This specification further provides a non-transitory computer-readable storage medium. The storage medium stores a computer program, and the computer program can be used to perform the intent recognition method shown in FIG. 1.

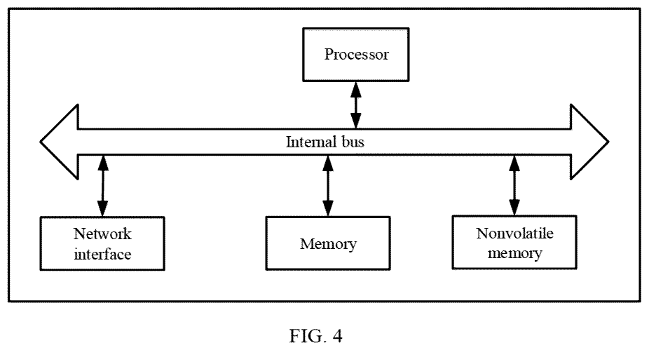

This specification further provides a schematic structural diagram of an electronic device shown in FIG. 4. As shown in FIG. 4, in terms of hardware, the electronic device includes a processor, an internal bus, a network interface, a memory, and a nonvolatile memory, and certainly may further include hardware needed by another service. The processor reads a corresponding computer program from the nonvolatile memory into the memory and then runs the computer program, to implement the intent recognition method shown in FIG. 1. Certainly, in addition to software implementations, another implementation is not excluded in this specification, for example, a logic device or a combination of hardware and software. In other words, an execution body of the following processing process is not limited to logical units, and can be hardware or a logic device.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer independently performs programming to “integrate” a digital system to a PLD without requesting a chip manufacturer to design and manufacture an application-specific integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). Currently, the Very-High-Speed Integrated Circuit Hardware Description Language (VHDL) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented in any appropriate manner. For example, the controller can be a microprocessor or a processor, or a computer readable medium that stores computer-readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. A storage controller can also be implemented as a part of control logic of a storage. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, or an embedded microcontroller. Therefore, the controller can be considered as a hardware component, and an apparatus configured to implement various functions in the controller can also be considered as a structure in the hardware component. Alternatively, the apparatus configured to implement various functions can even be considered as both a software module implementing the method and a structure in the hardware component.

The systems, apparatuses, modules, or units described in the above implementations can be specifically implemented by a computer chip or an entity, or can be implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above apparatus is described by dividing functions into various units. Certainly, when this specification is implemented, functions of the units can be implemented in one or more pieces of software and/or hardware.

A person skilled in the art should understand that the embodiments of this specification can be provided as methods, systems, or computer program products. Therefore, this specification can use a form of hardware only embodiments, software only embodiments, or embodiments with a combination of software and hardware. In addition, this specification can use a form of a computer program product that is implemented on one or more computer-usable storage media (including but not limited to a disk memory, a CD-ROM, an optical memory, etc.) that include computer-usable program code.

This specification is described with reference to the flowcharts and/or block diagrams of the method, the device (system), and the computer program product according to the embodiments of this specification. It should be understood that each procedure and/or block in the flowcharts and/or the block diagrams and a combination of procedures and/or blocks in the flowcharts and/or the block diagrams can be implemented by using computer program instructions. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable storage that can instruct a computer or another programmable data processing device to work in a specific manner, so that the instructions stored in the computer-readable storage generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory may include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer-readable medium includes persistent, non-persistent, removable and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

It should be further noted that the terms “include”, “comprise”, or any other variants thereof are intended to cover a non-exclusive inclusion, so that a process, a method, a product, or a device that includes a list of elements not only includes those elements but also includes other elements which are not expressly listed, or further includes elements inherent to such s process, method, product, or device. Without more constraints, an element preceded by “includes a . . . ” does not preclude the presence of additional identical elements in the process, method, product, or device that includes the element.

A person skilled in the art should understand that the embodiments of this specification can be provided as methods, systems, or computer program products. Therefore, this specification can use a form of hardware only embodiments, software only embodiments, or embodiments with a combination of software and hardware. In addition, this specification can use a form of a computer program product that is implemented on one or more computer-usable storage media (including but not limited to a disk memory, a CD-ROM, an optical memory, etc.) that include computer-usable program code.

This specification can be described in the general context of computer-executable instructions executed by a computer, for example, a program module. Usually, the program module includes a routine, a program, an object, a component, a data structure, etc. for executing a specific task or implementing a specific abstract data type. This specification can alternatively be practiced in distributed computing environments. In the distributed computing environments, tasks are executed by remote processing devices connected through a communication network. In the distributed computing environments, the program module can be located in both local and remote computer storage media including storage devices.

The embodiments of this specification are described in a progressive manner. For same or similar parts in the embodiments, mutual references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above descriptions are merely embodiments of this specification, and are not intended to limit this specification. A person skilled in the art can make various changes and variations to this specification. Any modifications, equivalent replacements, improvements, etc. made without departing from the spirit and principle of this specification shall fall within the scope of the claims of this specification.

1. An intent recognition method, wherein the method comprises:
receiving an intent recognition request, and determining reply information input by a target user for output information of an intelligent dialogue system as to-be-recognized information;
matching the to-be-recognized information with each preset keyword, to obtain a target keyword that matches the to-be-recognized information;
searching, based on the target keyword and a preset correspondence between historical output information and a keyword, a historical dialogue record of the target user for reference output information corresponding to the target keyword and reference reply information input by the target user for the reference output information; and
inputting the to-be-recognized information and the reference reply information to a pre-trained intent recognition model as inputs, to obtain an intent output by the pre-trained intent recognition model as a target intent of the to-be-recognized information, wherein
an intent recognition model is trained by using the following method:
determining a first training sample based on historical output information output by the intelligent dialogue system and historical reply information input by a reference user for the historical output information in a specified round of historical dialogue between the intelligent dialogue system and the reference user, determining a label of the first training sample based on an intent of the reference user corresponding to the specified round of historical dialogue, and training the intent recognition model based on the first training sample and the label of the first training sample.

2. The method according to claim 1, wherein the correspondence between the historical output information and the keyword is determined by using the following method:
obtaining historical dialogue records of a plurality of rounds of dialogues between the reference user and the intelligent dialogue system, wherein each round of historical dialogue record comprises historical output information output by the intelligent dialogue system and historical reply information input by the reference user for the historical output information;
selecting each piece of specified reply information corresponding to each piece of historical output information from all pieces of historical reply information;
determining at least one keyword corresponding to the historical output information based on each piece of specified reply information corresponding to the historical output information; and
determining the correspondence between the historical output information and the keyword based on the keyword corresponding to each piece of historical output information.

3. The method according to claim 2, wherein the selecting each piece of specified reply information corresponding to each piece of historical output information from all pieces of historical reply information comprises:
inputting each piece of historical reply information to a pre-trained classification model, to obtain probabilities, output by the classification model, that the historical reply information corresponds to all pieces of historical output information;
determining a difference between the probabilities that the historical reply information corresponds to all the pieces of historical output information, and using each piece of historical reply information whose difference is greater than a preset difference threshold as each piece of candidate reply information; and
selecting each piece of specified reply information corresponding to each piece of historical output information from all the pieces of historical reply information based on a probability that each piece of candidate reply information separately corresponds to the historical output information.

4. The method according to claim 3, wherein pre-training the classification model comprises:
using historical reply information input by the reference user in each round of historical dialogue record as a second training sample in advance, and using historical output information to which the historical reply information responds in the round of historical dialogue record as a label of the second training sample in advance;
inputting the second training sample to the to-be-trained classification model, to obtain prediction information that is of the second training sample and that is output by the classification model; and
training the classification model by using a training objective of minimizing a difference between the prediction information of the second training sample and the label of the second training sample.

5. The method according to claim 2, wherein the determining at least one keyword corresponding to the historical output information based on each piece of specified reply information corresponding to the historical output information comprises:
separately segmenting each piece of specified reply information corresponding to the historical output information, to obtain candidate words; and
inputting each of the candidate words to the pre-trained intent recognition model, and selecting the at least one keyword corresponding to the historical output information from the candidate words based on an output of the intent recognition model.

6. The method according to claim 1, wherein the output information that is of the intelligent dialogue system and to which the to-be-recognized information responds is a question used to ask whether the target user has an abnormal behavior; and
before the searching for reference output information corresponding to the target keyword and reference reply information input by the target user for the reference output information, the method further comprises:
determining that the to-be-recognized information comprises a negative word.

7. The method according to claim 1, wherein the method further comprises:
obtaining an intent of the target user corresponding to the reference reply information; and
adjusting the intent of the target user corresponding to the reference reply information based on the target intent, to determine, based on an adjusted intent, whether the target user has an abnormal behavior.

8-14. (canceled)

15. A non-transitory computer-readable storage medium, wherein the storage medium stores a computer program, and when the computer program is executed by a processor, the processor is caused to implement an intent recognition method, and the method comprises:
receiving an intent recognition request, and determining reply information input by a target user for output information of an intelligent dialogue system as to-be-recognized information;
matching the to-be-recognized information with each preset keyword, to obtain a target keyword that matches the to-be-recognized information;
searching, based on the target keyword and a preset correspondence between historical output information and a keyword, a historical dialogue record of the target user for reference output information corresponding to the target keyword and reference reply information input by the target user for the reference output information; and
inputting the to-be-recognized information and the reference reply information to a pre-trained intent recognition model as inputs, to obtain an intent output by the pre-trained intent recognition model as a target intent of the to-be-recognized information, wherein
an intent recognition model is trained by using the following method:
determining a first training sample based on historical output information output by the intelligent dialogue system and historical reply information input by a reference user for the historical output information in a specified round of historical dialogue between the intelligent dialogue system and the reference user, determining a label of the first training sample based on an intent of the reference user corresponding to the specified round of historical dialogue, and training the intent recognition model based on the first training sample and the label of the first training sample.

16. An electronic device, comprising a storage, a processor, and a computer program that is stored in the storage and that is capable of running on the processor, wherein when the processor executes the program, the processor is caused to implement an intent recognition method, and the method comprises:
receiving an intent recognition request, and determining reply information input by a target user for output information of an intelligent dialogue system as to-be-recognized information;
matching the to-be-recognized information with each preset keyword, to obtain a target keyword that matches the to-be-recognized information;
searching, based on the target keyword and a preset correspondence between historical output information and a keyword, a historical dialogue record of the target user for reference output information corresponding to the target keyword and reference reply information input by the target user for the reference output information; and
inputting the to-be-recognized information and the reference reply information to a pre-trained intent recognition model as inputs, to obtain an intent output by the pre-trained intent recognition model as a target intent of the to-be-recognized information, wherein
an intent recognition model is trained by using the following method:
determining a first training sample based on historical output information output by the intelligent dialogue system and historical reply information input by a reference user for the historical output information in a specified round of historical dialogue between the intelligent dialogue system and the reference user, determining a label of the first training sample based on an intent of the reference user corresponding to the specified round of historical dialogue, and training the intent recognition model based on the first training sample and the label of the first training sample.

17. The non-transitory computer-readable storage medium according to claim 15, wherein the correspondence between the historical output information and the keyword is determined by:
obtaining historical dialogue records of a plurality of rounds of dialogues between the reference user and the intelligent dialogue system, wherein each round of historical dialogue record comprises historical output information output by the intelligent dialogue system and historical reply information input by the reference user for the historical output information;
selecting each piece of specified reply information corresponding to each piece of historical output information from all pieces of historical reply information;
determining at least one keyword corresponding to the historical output information based on each piece of specified reply information corresponding to the historical output information; and
determining the correspondence between the historical output information and the keyword based on the keyword corresponding to each piece of historical output information.

18. The non-transitory computer-readable storage medium according to claim 17, wherein the selecting each piece of specified reply information corresponding to each piece of historical output information from all pieces of historical reply information comprises:
inputting each piece of historical reply information to a pre-trained classification model, to obtain probabilities, output by the classification model, that the historical reply information corresponds to all pieces of historical output information;
determining a difference between the probabilities that the historical reply information corresponds to all the pieces of historical output information, and using each piece of historical reply information whose difference is greater than a preset difference threshold as each piece of candidate reply information; and
selecting each piece of specified reply information corresponding to each piece of historical output information from all the pieces of historical reply information based on a probability that each piece of candidate reply information separately corresponds to the historical output information.

19. The non-transitory computer-readable storage medium according to claim 18, wherein pre-training the classification model comprises:
using historical reply information input by the reference user in each round of historical dialogue record as a second training sample in advance, and using historical output information to which the historical reply information responds in the round of historical dialogue record as a label of the second training sample in advance;
inputting the second training sample to the to-be-trained classification model, to obtain prediction information that is of the second training sample and that is output by the classification model; and
training the classification model by using a training objective of minimizing a difference between the prediction information of the second training sample and the label of the second training sample.

20. The non-transitory computer-readable storage medium according to claim 17, wherein the determining at least one keyword corresponding to the historical output information based on each piece of specified reply information corresponding to the historical output information comprises:
separately segmenting each piece of specified reply information corresponding to the historical output information, to obtain candidate words; and
inputting each of the candidate words to the pre-trained intent recognition model, and selecting the at least one keyword corresponding to the historical output information from the candidate words based on an output of the intent recognition model.

21. The non-transitory computer-readable storage medium according to claim 15, wherein the output information that is of the intelligent dialogue system and to which the to-be-recognized information responds is a question used to ask whether the target user has an abnormal behavior; and
before the searching for reference output information corresponding to the target keyword and reference reply information input by the target user for the reference output information, the processor is further caused to:
determine that the to-be-recognized information comprises a negative word.

22. The computing device according to claim 16, wherein the correspondence between the historical output information and the keyword is determined by:
obtaining historical dialogue records of a plurality of rounds of dialogues between the reference user and the intelligent dialogue system, wherein each round of historical dialogue record comprises historical output information output by the intelligent dialogue system and historical reply information input by the reference user for the historical output information;
selecting each piece of specified reply information corresponding to each piece of historical output information from all pieces of historical reply information;
determining at least one keyword corresponding to the historical output information based on each piece of specified reply information corresponding to the historical output information; and
determining the correspondence between the historical output information and the keyword based on the keyword corresponding to each piece of historical output information.

23. The computing device according to claim 22, wherein the selecting each piece of specified reply information corresponding to each piece of historical output information from all pieces of historical reply information comprises:
inputting each piece of historical reply information to a pre-trained classification model, to obtain probabilities, output by the classification model, that the historical reply information corresponds to all pieces of historical output information;
determining a difference between the probabilities that the historical reply information corresponds to all the pieces of historical output information, and using each piece of historical reply information whose difference is greater than a preset difference threshold as each piece of candidate reply information; and
selecting each piece of specified reply information corresponding to each piece of historical output information from all the pieces of historical reply information based on a probability that each piece of candidate reply information separately corresponds to the historical output information.

24. The computing device according to claim 23, wherein pre-training the classification model comprises:
using historical reply information input by the reference user in each round of historical dialogue record as a second training sample in advance, and using historical output information to which the historical reply information responds in the round of historical dialogue record as a label of the second training sample in advance;
inputting the second training sample to the to-be-trained classification model, to obtain prediction information that is of the second training sample and that is output by the classification model; and
training the classification model by using a training objective of minimizing a difference between the prediction information of the second training sample and the label of the second training sample.

25. The computing device according to claim 22, wherein the determining at least one keyword corresponding to the historical output information based on each piece of specified reply information corresponding to the historical output information comprises:
separately segmenting each piece of specified reply information corresponding to the historical output information, to obtain candidate words; and
inputting each of the candidate words to the pre-trained intent recognition model, and selecting the at least one keyword corresponding to the historical output information from the candidate words based on an output of the intent recognition model.

26. The computing device according to claim 16, wherein the output information that is of the intelligent dialogue system and to which the to-be-recognized information responds is a question used to ask whether the target user has an abnormal behavior; and
before the searching for reference output information corresponding to the target keyword and reference reply information input by the target user for the reference output information, and the computing device is further caused to:
determine that the to-be-recognized information comprises a negative word.

27. The computing device according to claim 16, wherein the computing device is further caused to:
obtain an intent of the target user corresponding to the reference reply information; and
adjust the intent of the target user corresponding to the reference reply information based on the target intent, to determine, based on an adjusted intent, whether the target user has an abnormal behavior.
